(19) United States
(12) Patent Application Publication
(10) Pub. No.: US 2023/0111979 A1
(43) Pub. Date: Apr. 13, 2023

(54) SYSTEMS AND METHODS FOR WIRELESS SURROUND SOUND

(71) Applicant: Fasetto, Inc., Scottsdale, AZ (US)

(72) Inventors: Coy Christmas, Scottsdale, AZ (US); AJ Santiago, Scottsdale, AZ (US); Kevin Wilson, Scottsdale, AZ (US); Erik W. Jones, Scottsdale, AZ (US); Mark Mendelson, Scottsdale, AZ (US); Edwin Berlin, Scottsdale, AZ (US)

(73) Assignee: Fasetto, Inc., Scottsdale, AZ (US)

(21) Appl. No.: 17/964,439

(22) Filed: Oct. 12, 2022

Related U.S. Application Data
(60) Provisional application No. 63/254,938, filed on Oct. 12, 2021.

(51) Int. Cl. H04S 1/00; H04S 7/00; H04L 65/70; H04L 65/80

(52) U.S. Cl. CPC H04S 1/007; H04S 7/307; H04L 65/70; H04L 65/80

(57) ABSTRACT

Systems and methods including one or more processors and one or more non-transitory storage devices storing computing instructions configured to run on the one or more processors and perform receiving audio source data at a speaker; applying, on the speaker, a digital signal processing algorithm to the audio source data to create post processed audio data; encoding, on the speaker, the post processed audio data; and outputting the post processed audio data, as encoded, via the speaker. Other embodiments are disclosed herein.

### CROSS-REFERENCE TO RELATED APPLICATIONS

This application claims the benefit of U.S. Provisional No. 63/254,938, filed Oct. 12, 2021, which is herein incorporated by this reference in its entirety.

### FIELD

The disclosure relates generally to wireless speaker systems and, more particularly to wireless surround sound speaker systems.

### BACKGROUND

Traditional surround sound speaker systems comprise a plurality of speakers which may be difficult to install, equalize, and operate in a home theater environment. Many of todays' high-end, at home, multi-speaker surround sound systems require cumbersome wires that need to be run throughout a room and connected with bulky receivers or pre-amplifiers. Consumer's demand for the best-quality audio while demanding spartan decor gave rise to soundbars, but soundbar systems do not deliver sufficient, high-quality audio. Furthermore, such systems are ill-suited for the advanced surround sound and effects found in high-end formats.

### SUMMARY

In various embodiments the present disclosure provides systems and methods for implementing surround sound. A system for implementing surround sound may comprise one or more processors and one or more non-transitory computer-readable storage devices storing computing instructions configured to run on the one or more processors and cause the one or more processors to perform: receiving audio source data at a speaker, applying, on the speaker, a digital signal processing algorithm to the audio source data to create post processed audio data, encoding, on the speaker, the post processed audio data, and outputting the post processed audio data, as encoded, via the speaker.

In various embodiments, the audio source data comprises a packet comprising a physical layer communication protocol portion followed by a standardized communication protocol header portion followed by a transport layer protocol portion and a standardized communication protocol message portion. In various embodiments, encoding the post processed audio data comprises splitting the post processed audio data into at least two different channels of audio data and adjusting a balance between frequency components of the at least two different channels of audio data. In various embodiments, adjusting the balance comprises applying one or more of an equalization effect and a filtering element.

In various embodiments, the speaker comprises a plurality of speakers and transmitting the post processed audio data, as encoded, comprises transmitting a first channel of audio data of the at least two different channels of audio data to a first speaker of the plurality of speakers and transmitting a second channel of audio data of the at least two different channels of audio data to a second speaker of the plurality of speakers that is different than the first speaker of the plurality of speakers. In various embodiments, the computing instructions are further configured to run on the one or more processors and cause the processors to perform receiving an alternating current signal from a power cable generating a time based signal using the alternating current signal and applying the digital signal processing algorithm comprises applying the digital signal processing algorithm to the audio source data and the time based signal to create the post processed audio data.

In various embodiments, generating the time based signal comprises generating the time based signal using the alternating current signal and a phase locked loop circuit. In various embodiments, the time based signal comprises a jitter-free reference frequency at a predetermined sample rate. In various embodiments, the computing instructions are further configured to run on the one or more processors and cause the processors to perform after receiving the audio source data at the speaker, applying a dropout mitigation method to the audio source data. In various embodiments, the dropout mitigation method comprises one or more of a packet interpolation method, a spectral analysis method, a packet substitution method using volume data, and a packet substitution method using lossy compressed packets.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosures, however, may best be obtained by referring to the detailed description and claims when considered in connection with the drawing figures, wherein like numerals denote like elements.

FIG. 1 is a block diagram illustrating various system components of a system for surround sound, in accordance with various embodiments;

FIG. 2 is a block diagram of a control module in a system for surround sound, in accordance with various embodiments;

FIG. 3 is a block diagram of a wireless speaker in a system for surround sound, in accordance with various embodiments;

FIG. 4 illustrates a data control scheme in a system for surround sound, in accordance with various embodiments;

FIG. 5 is a block diagram of a wireless speaker in a system for surround sound, in accordance with various embodiments;

FIG. 6 illustrates a process flow in a system for surround sound, in accordance with various embodiments.

### DETAILED DESCRIPTION

A number of embodiments can include a system. The system can include one or more processors and one or more non-transitory computer-readable storage devices storing computing instructions. The computing instructions can be configured to run on the one or more processors and cause the one or more processors to perform receiving audio source data at a speaker; applying, on the speaker, a digital signal processing algorithm to the audio source data to create post processed audio data; encoding, on the speaker, the post processed audio data; and outputting the post processed audio data, as encoded, via the speaker.

Various embodiments include a method. The method can be implemented via execution of computing instructions configured to run at one or more processors and configured to be stored at non-transitory computer-readable media. The method can comprise receiving audio source data at a speaker; applying, on the speaker, a digital signal processing algorithm to the audio source data to create post processed audio data; encoding, on the speaker, the post processed audio data; and outputting the post processed audio data, as encoded, via the speaker

The detailed description of exemplary embodiments herein makes reference to the accompanying drawings, which show exemplary embodiments by way of illustration and their best mode. While these exemplary embodiments are described in sufficient detail to enable those skilled in the art to practice the disclosures, it should be understood that other embodiments may be realized and that logical, chemical, and mechanical changes may be made without departing from the spirit and scope of the disclosures. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Audio systems such as home theater systems may have a plurality of speakers (e.g., 2, 4, 6, 8, 10, 12, 14, 34 or as many as may be desired by the user). Traditional central amplifier based systems tends to require many pairs of wires, most typically one pair of wires to drive each speaker. In this regard, traditional systems may be cumbersome and time consuming to install.

As described herein, the present system tends to mitigate the problems of traditional systems by providing each speaker with an independent power supply, amplifier, and data transport interfaces for streaming audio. In this regard, by placing the amplifier in the same enclosure as the speaker, the amplifier's power and spectral characteristics may be tuned to the characteristics of speaker and its enclosure, thereby boosting efficiency and sound quality. A transmitter unit (i.e., control module) for the speaker system may comprise an input section, a processing system, a Bluetooth transceiver, a data transport device, and a power supply.

The input section may accept audio signals in the form of HDMI, TOSLink, Digital coax, analog inputs; stored data such as .mp3 or .wav files, or data sources such as audio from streaming networks, computers, phones or tablets. The audio is input as or may be converted to one or more digital streams of uncompressed samples of 16, 24, 32 and/or other number of bits per sample at data rates of 44.1 ksps, 48 ksps, 96 ksps and/or other sample rates. The audio may be for multiple channels such as stereo, quadraphonic, 5.1, 7.1, and/or other formats. It may be formatted for processing through a spatializer such as, for example, DOLBY ATMOS™.

The processing system may perform several functions. It may resample the incoming audio signals and convert the stream to a desired output sample rate. It may process the audio, providing such Digital Signal Processing (DSP) functions as equalization, room acoustics compensation, speech enhancement, and/or add special effects such as echo and spatial separation enhancement. Effects may be applied to all audio channels, or separately to each speaker channel. The processing system may communicate with a smartphone or tablet through a BLUETOOTH® interface to allow user control of parameters such as volume, equalization levels, and/or choice of effects. The processed digital audio channels may be converted to a stream of packets which are sent to the speakers via the data transport device.

The transceiver provides a link between the processing system in the control module and a device such as a smartphone or tablet for user control of the system. It will be appreciate that a BLUETOOTH® interface is one exemplary interface type, other possibilities may include a WiFi, proprietary wireless link and/or a wired connection. The smartphone or tablet could be replaced with or augmented by a purpose-built interface device.

The data transport device may send the packetized digital audio data to the speaker modules. The method of transmission may be WiFi, HaLow, White Space Radio, 60 GHz radio, a proprietary radio design, and/or Ethernet over powerlines such as G.Hn. In various embodiments, most of the bandwidth (e.g., between 60% and 99%, or between 80% and 99%, or between 90% and 99%) for this device will be in the direction from the control module to the speakers, but a small amount of data may be sent in the other direction to discover active speakers in the system and/or comprise system control data. In addition to streaming audio data, some control information may be included in the packets to control aspects of the speaker operation. Such control information may include, for example, volume and mute functions, and control of any DSP functions which may be implemented in the speaker module. Another control function may include a wake up message to wake any speakers that are asleep (in low power mode) when the system is transitioning from being idle to being in use.

Digital audio data may be received by a data transport device of the speaker. This data passes through a processor of the speaker, which may alter the signal using DSP algorithms such as signal shaping to match the speaker characteristics. The drive signal needed for the particular speaker is sent to the amplifier, which drives the speaker. A power supply circuit supplies power to all the devices in the speaker unit.

Many data transport systems have limited bandwidth. To make the most use of this bandwidth, it may be advantageous to use data compression. Lossless compression, such as FLAC, can reduce the data rate while maintaining a desirable audio quality. Lossy compression can further reduce the required data rate, but at a detriment to sound quality. Choice of compression may depend on the number of speakers and the available bandwidth of the data transport system.

In various embodiments, the system may employ the User Datagram Protocol (UDP) for communication. The UDP comprises low-level packetized data communications which are not guaranteed to be received. No handshaking is expected, thereby reducing overhead. In contrast, Transmission Control Protocol (TCP) communications are packetized data which do guarantee delivery. However, TCP communications include a risk of delays due to retransmission, tending thereby to increase system latency beyond a threshold for practical use. For example, a wireless audio system, if used in conjunction with a video source, should have low latency to avoid problems with synchronization between the video and the audio. In various embodiments system latency is less than 25 ms, or less than 20 ms, or less than 15 ms, or below 5 ms.

In various embodiments, the system may employ one or more dropout mitigation methods depending on the character of the dropouts typically experienced by the data transport system. For example, if lost packets are infrequent, and the number of consecutive packets lost when there is a dropout is small (e.g., less than 4) then the system may employ a first method of handling lost packets. The first method may comprise filling the missing data in with an interpolation of the last sample received before the drop and the first sample received after the drop. A second method may comprise performing a spectral analysis of the last good packet received and the first good packet after the gap and then interpolating in the frequency and phase domains. A third method employed by the system to mitigate data dropouts is to determine where the audio from one channel is similar to that of another. In this regard, where one packet from a single speaker is lost, a corresponding packet for a different speaker may be substituted by the system without noticeable effect to the listener. This substitution may be enhanced by tracking and comparing the overall volume difference between several speakers and/or the difference in a number of frequency bands, to generate a packet substitution equalizer configured to make one channel sound more like another. A fourth method for handling dropped packets which may be employed by the system is to include in each packet a lossy compressed version of the following packet data. In normal operation, this lossy compressed data may be ignored. In response to a lost packet, the data for the lost packet may be constructed from the compressed data already received in the previous lossy compressed version of the associated packet.

In various embodiments, the system may perform time base correction. The control module may send data at a nominal rate (e.g. 48,000 samples per second). This rate may depend on a crystal oscillator or other time base in the control module or may be encoded on the data coming in to the unit. Therefore this frequency might be higher or lower than the nominal frequency by a small but measurable amount. Each speaker receives these packets of samples and must play them at exactly the rate at which they were generated in the control module. If, however, the speaker does not do this and instead uses its own time base which may be faster or slower than the time base in the control module, then, over time, the speaker will lead or lag the control module. In this regard, there will be a noticeable and objectionable time difference between speakers tending thereby to decrease sound quality for the listener. A further problem which may arise from using a local time base in each speaker is that, if the speaker runs slower than the control module, packets may tend to accumulate (say, in a First In First Out (FIFO) memory) until memory is exhausted. Where the speaker runs faster than the control module, no packets will be in the queue when the speaker is ready to output new samples.

The system may perform a time base correction process. First, packets that are received at the speaker are stored locally into a FIFO buffer of the speaker. The FIFO buffer may be empty on power up, but after a few packets are received, the FIFO buffer contains a nominal value of packets (e.g., 4 packets). Depending on the number of samples in a packet, this nominal value may be used to set the latency of the system. The FIFO buffer also enables the dropout mitigation method of filling in any missing packets, as described above. As new packets are inserted into the FIFO buffer, the FIFO buffer grows in size, and as packets are removed and sent to the speaker, the FIFO buffer shrinks. An oscillator that sets the sample output frequency may be controlled by a phase locked loop. The frequency control may be adjusted in the system software by the processing unit in the speaker. If the FIFO buffer has fewer than the nominal number of packets in it, the output sample rate is reduced responsively. If the FIFO buffer has more than the nominal number of packets in it, the output sample rate is increased responsively. In this way, the system may maintain roughly the correct output rate.

When the number of packets in the FIFO buffer is exactly the nominal number, the system may match the frequency of the incoming packets using a phase comparator and a loop filter. Every time a packet is received by the processor, the processor time stamps the reception event. The time stamp may be a counter that is driven by the oscillator. In this regard, the oscillator may also set the output frequency. By measuring using this clock, the system may match the sample rate at the control module when it measures the exact same frequency at the speaker. The time stamp is generated with sufficient resolution to provide many bits of accuracy in measuring the phase of the incoming packets relative to the output sample rate. This phase measurement may then be low pass filtered and used as in input by the system to adjust the oscillator frequency of the phase locked loop. In this regard, the system may provide a stable output frequency that matches and tracks the average frequency of the samples at the control module.

In various embodiments, to enable the control module to identify which speakers are active, each speaker may send a “heartbeat” packet to the transmitter unit at a low frequency such as, for example, 5 Hz. The heartbeat packet may comprise information about the speaker, such, for example, as its placement (e.g., Right Front, Center, Rear Left, Subwoofer, etc.), its specific channel number, and/or an IP address. The control module may monitor the various heartbeat packets with a timeout process to determine which of the plurality of speakers are currently active and available for playing audio. The control module may provide this information to the user via an app native to the user device.

When all audio sources are idle and/or when the control module is turned off, the control module may transmit a command to each of the plurality of speakers to enter a sleep mode. In the sleep mode, the speakers reduce their power draw from an operating power to a low power draw. While in sleep mode, the speakers may periodically monitor the transport channel only to determine if the transmitter is commanding them to wake again in preparation for use

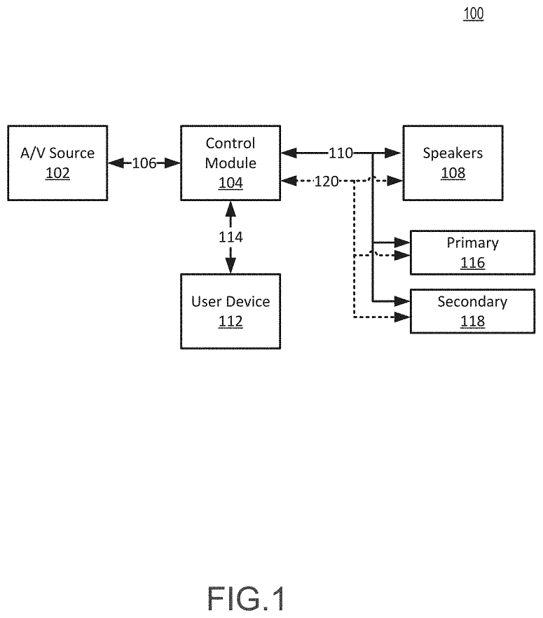

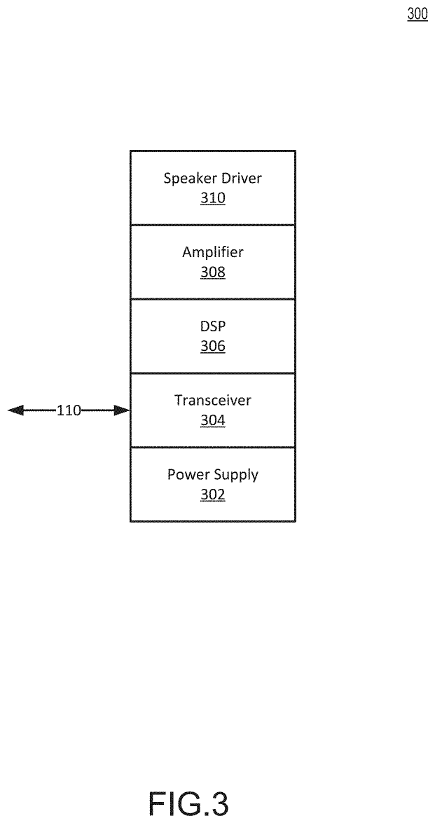

In various embodiments and with reference to FIG. 1, an exemplary system 100 for wireless surround sound is illustrated. System 100 may include an audio/visual source (A/V source) 102, a control module 104, one or more speakers (e.g., a plurality of wireless speakers 108), and a user device 112. The speakers 108 include at least one primary speaker 116 (e.g., a front speaker) and a secondary speaker 118 such as, for example, a subwoofer or a rear speaker. The speakers 108 are described in more detail below and with reference to FIG. 3.

In various embodiments, control module 104 may be configured as a central network element or hub to access various systems, engines, and components of system 100. Control module 104 may be a computer-based system, and/or software components configured to provide an access point to various systems, engines, and components of system 100. Control module 104 may be in communication with the A/V source 102 via a first interface 106. The control module may be in communication with the speakers 108 via a second interface 110. In various embodiments the control module 104 may be communication with the speakers 108 via a fourth interface 120. The control module 104 may communicate with the speakers 108 via the second interface 110 and the fourth interface 120 simultaneously. The control module 104 may be in communication with the user device 112 via a third interface 114. In this regard, the control module 104 may allow communications from the user device 112 to the various systems, engines, and components of system 100 (such as, for example, speakers 108 and/or A/V source 102). In this regard, the system may transmit a high definition audio signal along with data (e.g., command and control signals, etc.) to any type or number of speakers configured to communicate with the control module 104.

In various embodiments the first interface 106 may be an audio and/or visual interface such as, for example, High-Definition Multimedia Interface (HDMI), DisplayPort, USB-C, AES3, AES47, S/PDIF, BLUETOOTH®, and/or the like. In various embodiments, any of the first interface 106, the second interface 110, and/or the third interface 114 may be a wireless data interface such as, for example, one operating on a physical layer protocol such as IEEE 802.11, IEEE 802.15, BLUETOOTH®, and/or the like. In various embodiments, the fourth interface 120 may be a Powerline Communication (PLC) type interface configure to carry audio data. As described in further detail below, each of the various systems, engines, and components of system 100 may be further configured to communicate via the GRAVITY™ Standardized Communication Protocol (SCP) for wireless devices operable on the physical layer protocol as described in further detail below that is being offered by Fasetto, Inc. of Scottsdale, Ariz.

In various embodiments, a user device 112 may comprise software and/or hardware in communication with the system 100 via the third interface 114 comprising hardware and/or software configured to allow a user, and/or the like, access to the control module 104. The user device may comprise any suitable device that is configured to allow a user to communicate via the third interface 114 and the system 100. The user device may include, for example, a personal computer, personal digital assistant, cellular phone, a remote control device, and/or the like and may allow a user to transmit instructions to the system 100. In various embodiments, the user device 112 described herein may run a web application or native application to communicate with the control module 104. A native application may be installed on the user device 112 via download, physical media, or an app store, for example. The native application may utilize the development code base provided for use with an operating system of the user device 112 and be capable of performing system calls to manipulate the stored and displayed data on the user device 112 and communicates with control module 104. A web application may be web browser compatible and written specifically to run on a web browser. The web application may thus be a browser-based application that operates in conjunction with the system 100.

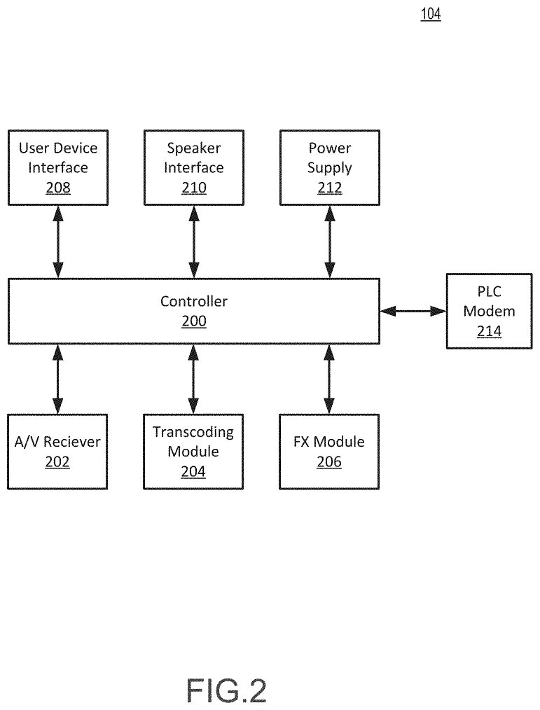

In various embodiments and with additional reference to FIG. 2, control module 104 is illustrated. Control module 104 may include a controller 200, an A/V receiver 202, a transcoding module 204, an effects processing module (FX module) 206, a user device interface 208, a speaker interface 210 (such as, for example, a transmitter or transceiver), a power supply 212, and a Powerline Communication modulator-demodulator (PLC modem) 214.

In various embodiments, controller 200 may comprise a processor and may be configured as a central network element or hub to access various systems, engines, and components of system 100. In various embodiments, controller 200 may be implemented in a single processor. In various embodiments, controller 200 may be implemented as and may include one or more processors and/or one or more tangible, non-transitory memories and be capable of implementing logic. Each processor can be a general purpose processor, a digital signal processor (DSP), an application specific integrated circuit (ASIC), a field programmable gate array (FPGA) or other programmable logic device, discrete gate or transistor logic, discrete hardware components, or any combination thereof. Controller 200 may comprise a processor configured to implement various logical operations in response to execution of instructions, for example, instructions stored on a non-transitory, tangible, computer-readable medium configured to communicate with controller 200.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In various embodiments the A/V receiver 202 is configured to receive source audio data from the A/V source 102 via the first interface 106. Controller 200 may pass the source audio data to the transcoding module 204 for further processing. In various embodiments, the transcoding module 204 is configured to perform conversion operations between a first encoding and a second encoding. For example, transcoding module 204 may convert the source audio from the first encoding to the second encoding to generate a transcoded audio data for further processing by the FX module 206. In various embodiments, the transcoding module 204 may be configured to decode and/or transcode one or more channels of audio information contained within the source audio data such as, for example, information encoded as Dolby Digital, DTS, ATMOS, Sony Dynamic Digital Sound (SDDS), and/or the like. In this regard, the transcoding module 204 may generate a transcoded audio data comprising a plurality of channels of audio information which may be further processed by the system.

In various embodiments, the FX module 206 may comprise one or more digital signal processing (DSP) elements or may be configured to adjust the balance between frequency components of the transcoded audio data. In this regard the FX module 206 may behave as an equalization module to strengthen or weaken the energy of one or more frequency bands within the transcoded audio data. In various embodiments, the FX module 206 may include one or more filtering elements such as, for example, band-pass filters configured to eliminate or reduce undesired and/or unwanted elements of the source audio data. Similarly, the FX module may include one or more effects elements and/or effects functions configured to alter the transcoded audio data. For example, the effects functions may enhance the data quality of the transcoded audio data, may correct for room modes, may apply distortion effects, dynamic effects, modulation, pitch/frequency shifting, time-based, feedback, sustain, equalization, and/or other effects. In various embodiments, the FX module may be software defined and/or may be configured to receive over-the-air updates. In this regard, the system may enable loading of new and/or user defined effects functions. In various embodiments, the FX module 206 may be configured to apply any number of effects functions to the transcoded audio data to generate a desired effected audio data comprising the channels of audio information. In various embodiments, the FX Module 206 may also resample the audio stream to alter the data rate. Controller 200 may pass the effected audio data to the speaker interface 210.

In various embodiments, DSP functionality of the FX module resides completely in the control module 104 and no additional processing occurs at the speakers. In a various embodiments and as discussed below with brief additional reference to FIG. 3, the FX module 206 functionality may be subsumed by a DSP 306 of each of the plurality of speakers 300. In this regard, the size and complexity of the control module 104 may be reduced by implementing the software defined FX module functionality via the DSP locally within one or more of the plurality of speakers 300.

In various embodiments, the speaker interface 210 may be configured to communicate via the second interface 110 with the plurality of speakers 108. In various embodiments, the speaker interface 210 may comprise a plurality of communication channels each of which are associated with a speaker of the plurality of speakers 108. The controller 200 may assign each of the channels of audio information to the plurality of speakers 108. For example, the speaker interface 210 may assign a first channel of the effected audio data to a communication channel for the primary speaker 116 and may assign a second channel of the effected audio data to a communication channel for the secondary speaker 118. In this regard, the system may assign the plurality of channels of audio information to the plurality of speakers on a one-to-one basis. Thereby the speaker interface 210 may facilitate streaming, by the processor, the various channels of audio information to the speakers. In various embodiments, the speaker interface 210 may be further configured to distribute instructions (e.g., control commands) to the speakers.

In various embodiments, speaker interface 210 may include the PLC modem 214. In this regard the speaker interface 210 may be configured to communicate with the plurality of speakers 108 via the fourth interface 120. The speaker interface 210 may be configured to distribute only control commands via the second interface 110 and to distribute only audio information via the fourth interface 120. In various embodiments, the speaker interface may be configured to distribute all control commands and audio data via only the second interface 110 or via only the fourth interface 120.

In various embodiments, the user device interface 208 is configured to enable communication between the controller 200 and the user device 112 via the third interface 114. The user device interface 208 may be configured to receive control commands from the user device 112. The user device interface 208 may be configured to return command confirmations or to return other data to the user device 112. For example, the user device interface 208 may be configured to return performance information about the control module 104, the effected audio data, speaker interface 210 status, speakers 108 performance or status, and/or the like. In various embodiments, the user device interface 208 may be further configured to receive source audio data from the user device 112.

In various embodiments, the power supply 212 is configured to receive electrical power. The power supply 212 may be further configured to distribute the received electrical power to the various components of system 100.

In various embodiments and with additional reference to FIG. 3, an exemplary speaker 300 of the plurality of speakers 108 is illustrated. Speaker 300 includes a power supply 302 configured to receive electrical power and distribute the electrical power to the various components of speaker 300. Speaker 300 may further comprise a transceiver 304, a DSP 306, an amplifier 308, and a speaker driver 310. In various embodiments, transceiver 304 is configured to receive the assigned channel of audio information and the control commands from the control module 104 via the second interface 110. In various embodiments, the transceiver may be further configured to pass status information and other data about the speaker 300 to the control module 104. In various embodiments, the transceiver 304 may be configured to communicate directly with the user device 112.

In various embodiments, the DSP 306 may be configured receive the assigned channel of audio and apply one or more digital signal processing functions, such as, for example sound effect algorithms, to the audio data. In this regard, the DSP 306 may perform further effect functions to audio data which has already been processed by the FX module 206. In various embodiments, the DSP 306 may perform further processing in response to commands from the control module 104. For example, the control module may command the DSP to apply processing functions to equalize the speaker 300 output based on its particular location within a room, to emulate a desired room profile, to add one or more effectors (e.g., reverb, echo, gate, flange, chorus, etc.), and/or the like. As discussed above, various embodiments the DSP 306 may include and implement all the functionality of the FX module 206 which may be software defined. In this regard, the DSP 306 may generate a DSP audio channel which may be passed to the amplifier 308 for further processing. The amplifier 308 may receive the DSP audio channel and may amplify the signal strength of the DSP audio channel to generate a drive signal which may be passed to the speaker driver 310. In various embodiments, the speaker driver 310 may receive the drive signal from the amplifier 308 and in response convert the drive signal 310 to sound.

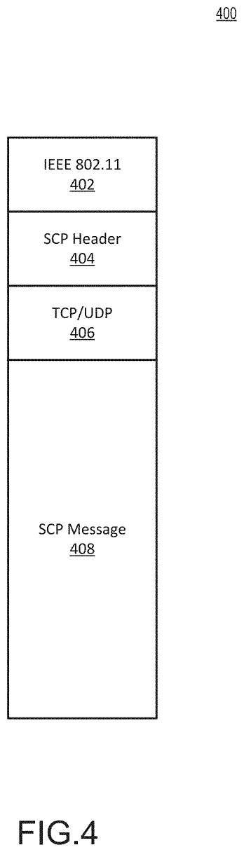

As discussed above and with additional reference to FIG. 4, a schematic diagram of a data control scheme for wireless surround sound is illustrated. In various embodiments, each of the user device 112, the A/V Source 102, the control module 104, and the speakers 108 may be further configured to communicate via the SCP. In various embodiments, the SCP may comprise a network layer protocol. In various embodiments, system may prepend an SCP header 404 to a packet or datagram 400. In this regard SCP header may be interposed between the physical layer communication protocol 402 (e.g, 802.11, 802.15, etc.) data and a transport layer protocol 406 (e.g., TCP/IP, UDP, DCCP, etc.) data. The system 100 elements may be configured to recognize the SCP header 404 to identify an associated SCP message 408. The system may then execute various actions or instructions based on the SCP message 408.

For example, the SCP may define the ability of devices (such as, for example, the speakers 108, the control module 104, and the user device 112) to discover one another, to request the transfer of raw data, to transmit confirmations on receipt of data, and to perform steps involved with transmitting data. The SCP may define various control commands to the speaker 300 to switch or apply the various DSP functions, to turn on or off the power supply 302, to affect the signal strength output by the amplifier 308, and/or the like. In various embodiments, the SCP may define the ability of the control module 104 to alter the effects functions of the FX module 206 and/or the DSP 306, to select codes of the transcoding module 204, to select audio source data, to power on or off the power supply 212, to assign or modify interfaces of the speaker interface 210, and or the like. In this regard, as implemented in s system 100 the SCP enables discrete control over each of the plurality of speakers 300 in real time to deploy audio signal processing functions to selected individual speakers (e.g., primary 116) or groups of speakers (e.g., primary speaker 116 and secondary speaker 118) such as, for example, frequency-shaping, dialogue-enhancement, room mode correction, effects functions, equalization functions, tone control, balance, level and volume control, etc. System 100 thereby enables individualized control of the sound output characteristics of speakers 300.

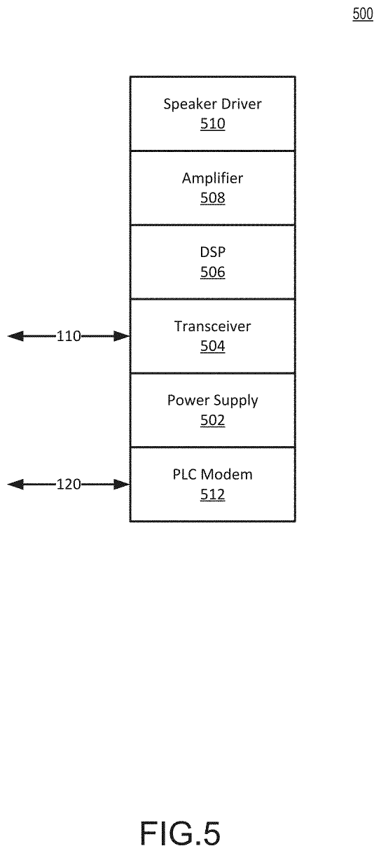

With additional reference to FIG. 5, an exemplary speaker 500 of the plurality of speakers 108 is illustrated. Speaker 500 comprises features, geometries, construction, materials, manufacturing techniques, and/or internal components similar to speaker 300 but includes a PLC Modem 512. Speaker 500 a power supply 502 configured to receive electrical power and distribute the electrical power to the various components of speaker 500. In various embodiments, the PLC modem 512 may comprise a module of the power supply 502. Speaker 500 may further comprise a transceiver 504, a DSP 506, an amplifier 508, and a speaker driver 510. In various embodiments, transceiver 504 is configured to receive the control commands from the control module 104 via the second interface 110.

The PLC modem 512 may be configured to receive audio information via the fourth interface 120 such as, for example, the plurality of channels of audio information which may be broadcast from the control module 104 to the speaker 500. In various embodiments, the control commands may include an instruction to the PLC modem regarding the assigned channel of audio information such as a channel selection. The PLC modem 512 may be configured to strip the assigned channel of audio information from the plurality of channels of audio information based on the channel selection. In various embodiments, the transceiver 504 may be further configured to pass status information and other data about the speaker 500 to the control module 104. In various embodiments, the transceiver 504 may be configured to communicate directly with the user device 112.

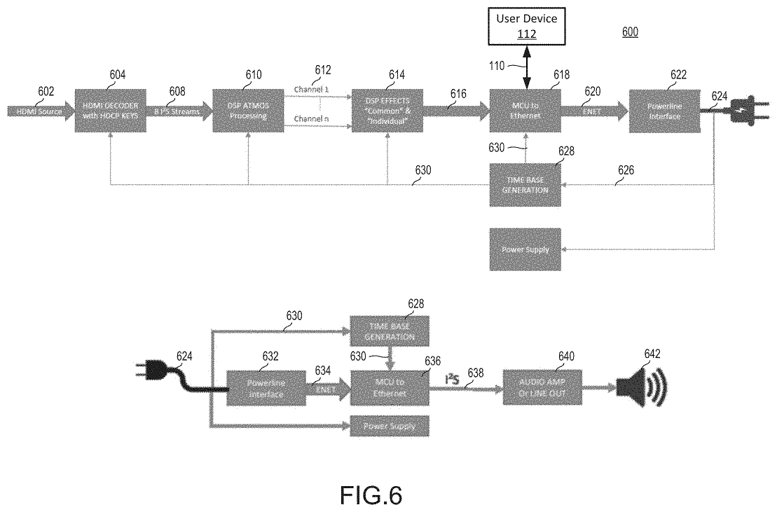

With additional reference to FIG. 6, a process 600 for streaming audio data in system 100 is illustrated in accordance with various embodiments. The system may receive audio source data 602 such as, for example, an HDMI source via the first interface 106. The audio source data 602 may be encrypted. The system may decrypt the audio source data via, for example, a decryption module or algorithm (e.g. an HDMI decoder with HDCP keys) (step 604). In response, the system may generate one or more decrypted data streams 608. For example, the audio source data may be 8 channel audio source data and the output of the HDMI decoder may be 8 channel parallel I2S streams of data.

The system may apply a first Digital Signal Processing (DSP) algorithm to the decrypted data streams (step 610). For example, the system may apply DOLBY ATMOS™ processing which may generate up to 34 channels of audio from the 8 channels of data decoded in step 604. In response to applying the first DSP algorithm, the system may generate a plurality of channels of audio data 612. In various embodiments the system may apply additional DSP algorithms (e.g., a second DSP algorithm, a third DSP algorithm, . . . an nth DSP algorithm) to the plurality of channels of audio data (step 614). The further processing of 614 may include volume, equalization, or other effects as desired. The effects may be applied to all channels, or separately to each channel on an individual or group basis. In various embodiments, each channel of the plurality of channels of audio data may be processed by a channel specific DSP algorithm (i.e., algorithms assigned on a one-to-one basis for each of the plurality of channels of audio data). In this regard, the system may generate a post processed audio data (e.g., the effected data) 616. The post processed audio data may comprise a plurality of audio streams associated on a one-to-one basis with each speaker of the plurality of speakers. In various embodiments, additional processing may be applied to convert the sample rate to match the sample rate provided by a time base signal generated by a time base generation process 628 as described below.

In various embodiments, the post processed audio data 616 may be encoded to generate encoded post processed audio data 620 for transmission to the plurality of speakers (step 618). For example, the post processed a data 616 may be encoded as ethernet data. The audio streams may be loaded into packets and sent at a rate dictated by the sample rate set by the time base signal. The encoded post processed audio data 620 may be passed to the fourth interface for transmission (step 622). For example, ethernet encoded data may be passed to an ethernet type PLC modem implementing a protocol such as H.Gn coupled to power cable 624.

In various embodiments, the system may receive a power signal 626 from the power cable 624. The power signal may be an alternating current signal at or between 50 Hz and 60 Hz or may be another signal modulated over the power cable 624. Process 628 may generate a time base signal based on the power signal. In various embodiments, process 628 may comprise a phase locked loop circuit which generates a relatively jitter-free reference frequency at a desired sample rate and its multiples. For example, process 628 may generate a 48 kHz sample rate and 256*48 kHz, or 12.288 MHz, as a reference clock or time base signal 630 which may be used to drive the digital signal processing and the various systems and modules of system 100 and process 600.

At each speaker, a PLC modem 632 may receive the encoded data and extract the ethernet packets 634. The PLC modem 632 may pass the ethernet packets 634 to a processor 636 of the speaker for further processing. The processor 636 may accept only those packets addressed to the corresponding speaker 642. The processor 636 may reconstruct the packets to generate audio data 638 and pass the audio data 638 to a digital input audio amplifier 640 configured to drive the speaker 642. In various embodiments, the audio data may be passed via I2S.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures.

The scope of the disclosures is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiment

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system comprising:
one or more processors; and
one or more non-transitory computer-readable storage devices storing computing instructions configured to run on the one or more processors and cause the one or more processors to perform:
receiving audio source data at a speaker;
applying, on the speaker, a digital signal processing algorithm to the audio source data to create post processed audio data;
encoding, on the speaker, the post processed audio data; and
outputting the post processed audio data, as encoded, via the speaker.

2. The system of claim 1, wherein the audio source data comprises a packet comprising:
(1) a physical layer communication protocol portion followed by (2) a standardized communication protocol header portion followed by (3) a transport layer protocol portion; and (4) a standardized communication protocol message portion.

3. The system of claim 1, wherein encoding the post processed audio data comprises:
splitting the post processed audio data into at least two different channels of audio data; and
adjusting a balance between frequency components of the at least two different channels of audio data.

4. The system of claim 3, wherein adjusting the balance comprises:
applying one or more of an equalization effect and a filtering element.

5. The system of claim 3, wherein:
the speaker comprises a plurality of speakers; and
transmitting the post processed audio data, as encoded, comprises:
transmitting a first channel of audio data of the at least two different channels of audio data to a first speaker of the plurality of speakers; and
transmitting a second channel of audio data of the at least two different channels of audio data to a second speaker of the plurality of speakers that is different than the first speaker of the plurality of speakers.

6. The system of claim 1, wherein:
the computing instructions are further configured to run on the one or more processors and cause the processors to perform:
receiving an alternating current signal from a power cable;
generating a time based signal using the alternating current signal; and
applying the digital signal processing algorithm comprises:
applying the digital signal processing algorithm to the audio source data and the time based signal to create the post processed audio data.

7. The system of claim 6, wherein generating the time based signal comprises:
generating the time based signal using the alternating current signal and a phase locked loop circuit.

8. The system of claim 6, wherein the time based signal comprises a jitter-free reference frequency at a predetermined sample rate.

9. The system of claim 1, wherein the computing instructions are further configured to run on the one or more processors and cause the processors to perform:
after receiving the audio source data at the speaker, applying a dropout mitigation method to the audio source data.

10. The system of claim 9, wherein the dropout mitigation method comprises one or more of (1) a packet interpolation method, (2) a spectral analysis method, (3) a packet substitution method using volume data, and (4) a packet substitution method using lossy compressed packets.

11. A method implemented via execution of computing instructions configured to run at one or more processors and configured to be stored at non-transitory computer-readable media, the method comprising:
receiving audio source data at a speaker;
applying, on the speaker, a digital signal processing algorithm to the audio source data to create post processed audio data;
encoding, on the speaker, the post processed audio data; and
outputting the post processed audio data, as encoded, via the speaker.

12. The method of claim 11, wherein the audio source data comprises a packet comprising:
(1) a physical layer communication protocol portion followed by (2) a standardized communication protocol header portion followed by (3) a transport layer protocol portion; and (4) a standardized communication protocol message portion.

13. The method of claim 11, wherein encoding the post processed audio data comprises:
splitting the post processed audio data into at least two different channels of audio data; and
adjusting a balance between frequency components of the at least two different channels of audio data.

14. The method of claim 13, wherein adjusting the balance comprises:
applying one or more of an equalization effect and a filtering element.

15. The method of claim 13, wherein:
the speaker comprises a plurality of speakers; and
transmitting the post processed audio data, as encoded, comprises:
transmitting a first channel of audio data of the at least two different channels of audio data to a first speaker of the plurality of speakers; and
transmitting a second channel of audio data of the at least two different channels of audio data to a second speaker of the plurality of speakers that is different than the first speaker of the plurality of speakers.

16. The method of claim 11, wherein:
the method further comprises:
receiving an alternating current signal from a power cable;
generating a time based signal using the alternating current signal; and
applying the digital signal processing algorithm comprises:
applying the digital signal processing algorithm to the audio source data and the time based signal to create the post processed audio data.

17. The method of claim 16, wherein generating the time based signal comprises:
generating the time based signal using the alternating current signal and a phase locked loop circuit.

18. The method of claim 16, wherein the time based signal comprises a jitter-free reference frequency at a predetermined sample rate.

19. The method of claim 11 further comprising:
after receiving the audio source data at the speaker, applying a dropout mitigation method to the audio source data.

20. The method of claim 19, wherein the dropout mitigation method comprises one or more of (1) a packet interpolation method, (2) a spectral analysis method, (3) a packet substitution method using volume data, and (4) a packet substitution method using lossy compressed packets.

21. An article of manufacture including a non-transitory, tangible computer readable storage medium having instructions stored thereon that, in response to execution by a processor, cause the processor to perform:
receiving audio source data at a speaker;
applying, on the speaker, a digital signal processing algorithm to the audio source data to create post processed audio data;
encoding, on the speaker, the post processed audio data; and
outputting the post processed audio data, as encoded, via the speaker.

22. The article of manufacture of claim 21, wherein the audio source data comprises a packet comprising:
(1) a physical layer communication protocol portion followed by (2) a standardized communication protocol header portion followed by (3) a transport layer protocol portion; and (4) a standardized communication protocol message portion.

23. The article of manufacture of claim 21, wherein encoding the post processed audio data comprises:
splitting the post processed audio data into at least two different channels of audio data; and
adjusting a balance between frequency components of the at least two different channels of audio data.

24. The article of manufacture of claim 23, wherein adjusting the balance comprises:
applying one or more of an equalization effect and a filtering element.

25. The article of manufacture of claim 23, wherein:
the speaker comprises a plurality of speakers; and
transmitting the post processed audio data, as encoded, comprises:
transmitting a first channel of audio data of the at least two different channels of audio data to a first speaker of the plurality of speakers; and
transmitting a second channel of audio data of the at least two different channels of audio data to a second speaker of the plurality of speakers that is different than the first speaker of the plurality of speakers.

26. The article of manufacture of claim 21, wherein:
the method further comprises:
receiving an alternating current signal from a power cable;
generating a time based signal using the alternating current signal; and
applying the digital signal processing algorithm comprises:
applying the digital signal processing algorithm to the audio source data and the time based signal to create the post processed audio data.

27. The article of manufacture of claim 26, wherein generating the time based signal comprises:
generating the time based signal using the alternating current signal and a phase locked loop circuit.

28. The article of manufacture of claim 26, wherein the time based signal comprises a jitter-free reference frequency at a predetermined sample rate.

29. The article of manufacture of claim 21, wherein the instructions :
after receiving the audio source data at the speaker, applying a dropout mitigation method to the audio source data.

30. The article of manufacture of claim 29, wherein the dropout mitigation method comprises one or more of (1) a packet interpolation method, (2) a spectral analysis method, (3) a packet substitution method using volume data, and (4) a packet substitution method using lossy compressed packets.
